(19) United States
(12) Patent Application Publication
(10) Pub. No.: US 2008/0040086 A1
(43) Pub. Date: Feb. 14, 2008

(54) FACILITATING OILFIELD DEVELOPMENT WITH DOWNHOLE FLUID ANALYSIS

(75) Inventors: Soraya S. Betancourt, Cambridge, MA (US); Oliver C. Mullins, Ridgefield, CT (US); Rimas Gaizutis, Kuala Lumpur (MY); ChengGang Xian, Tripoli (LY); Peter Kaufman, Highlands Ranch, CO (US); Francois Dubost, Orgeval (FR); Lalitha Venkataramanan, Lexington, MA (US)

Correspondence Address: Schlumberger Technology Corporation, P. O. Box 425045, Cambridge, MA, 02142, US

(73) Assignee: SCHLUMBERGER TECHNOLOGY CORPORATION, Cambridge, MA (US)

(21) Appl. No.: 11/832,290

(22) Filed: Aug. 1, 2007

Related U.S. Application Data
(60) Provisional application No. 60/836,548, filed on Aug. 9, 2006.

(51) Int. Cl. G01V 9/00; G06F 19/00; G06G 7/48

(52) U.S. Cl. 703/10; 702/11; 73/152.28

(57) ABSTRACT

Formation fluid data based on measurements taken downhole under natural conditions is utilized to help identify reservoir compartments. A geological model of the reservoir including expected pressure and temperature conditions is integrated with a predicted fluid model fitted to measured composition and PVT data on reservoir fluid samples or representative analog. Synthetic downhole fluid analysis (DFA) logs created from the predictive fluid model can be displayed along the proposed borehole trajectory by geological modeling software prior to data acquisition. During a downhole fluid sampling operation, actual measurements can be displayed next to the predicted logs. If agreement exists between the predicted and measured fluid samples, the geologic and fluid models are validated. However, if there is a discrepancy between the predicted and measured fluid samples, the geological model and the fluid model need to be re-analyzed, e.g., to identify reservoir fluid compartments. A quantitative comparative analysis of the sampled fluids can be performed against other samples in the same borehole or in different boreholes in the field or region to calculate the statistical similarity of the fluids, and thus the possible connectivity between two or more reservoir regions.

### CROSS-REFERENCE TO RELATED APPLICATIONS

A claim of priority is made to United States Provisional Patent Application 60/836,548, titled DOWNHOLE FLUID ANALYSIS WORKFLOW FOR OILFIELD DEVELOPMENT, filed Aug. 9, 2006, which is incorporated by reference.

### FIELD OF THE INVENTION

This invention is generally related to oil and gas wells, and more particularly to in situ analysis of formation fluid in a hydrocarbon reservoir to generate a fluid model which is integrated with a geological model to help identify reservoir features that are relevant to borehole completion and reservoir development.

### BACKGROUND OF THE INVENTION

One impediment to efficient development of oil and gas fields is reservoir compartmentalization. Reservoir compartmentalization is the natural occurrence of hydraulically isolated pockets within a single field. In order to produce an oil reservoir in an efficient manner it is necessary to know the structure of the field and the level of compartmentalization. A reservoir compartment cannot be produced unless it is drained by a well within it, and in order to justify the drilling of a well, the hydraulic compartment must be sufficiently large to sustain economic production. Further, in order to achieve efficient recovery, it is generally desirable to know the locations of as many of the isolated pockets in a field as practical before extensive field development has been done.

Techniques are known for generating models which predict and describe hydraulically isolated pockets of hydrocarbons. For example, geological models are built from data acquired during the exploration stage, such as seismic surfaces, well tops, formation evaluation logs, and pressure measurements. Fluid models are built with the input from lab pressure-volume-temperature (PVT) analyses, geochemistry studies, pressure gradients, and downhole fluid analysis (DFA). Fluid models can be used in conjunction with geological models to achieve a better understanding of the field. However, prior to the field development stage, the uncertainty in these models is relatively high. Consequently, combining the geological model and the fluids model in a reservoir simulation model yields a coarsened representation of the geological model with limited use, e.g., history matching and production forecasting.

Because of the limitations discussed above, known reservoir simulation models are not always available early enough, and with sufficient accuracy, to permit efficient field development. This is a problem because relatively greater risk exists in the field development stage in comparison with the exploration stage. Activity tends to occur at a faster pace in the field development stage. For example, the operator decides which zones are to be completed immediately after logging and sampling operations. The zones are selected based on predicted commercial value as indicated by the volume of reserves represented in existing models. If a mistake is made because of model inaccuracy, a costly workover operation and delayed production may result. The risks are particularly high in the case of offshore development because of higher development and operating costs. It would therefore be desirable to have more accurate and timely models.

### SUMMARY OF THE INVENTION

In accordance with one embodiment of the invention, a method for identifying hydraulically isolated units in a geological formation comprises the steps of: obtaining a sample of formation fluid at a selected location; measuring at least one property of the formation fluid within the borehole; and utilizing the measured property to identify a hydraulically isolated geological unit.

In accordance with another embodiment of the invention, a computer readable medium encoded with program code for identifying hydraulically isolated geological units in a formations comprises: logic for generating a measurement of at least one property of the formation fluid within the borehole from a sample of formation fluid obtained at a selected location; and logic for utilizing the measured property to identify a hydraulically isolated geological unit.

In accordance with another embodiment of the invention, apparatus for identifying hydraulically isolated geological units in a formations comprises: a formation analysis tool operable to obtain a sample of formation fluid at a selected location, and to measure at least one property of the formation fluid within the borehole; and a control unit operable to utilize the measured property to identify a hydraulically isolated geological unit.

An object of at least one embodiment of the invention is to help verify a geological model, including identification and location of hydraulically isolated regions. Generally, the geological model is the most detailed representation of the reservoir before the field development stage. The geological model may be directly integrated with a calibrated fluids model, eliminating the need for history matching and forecasting stages of dynamic reservoir simulation during exploration, when production data is not yet available. Further, the integrated model can be used to generate synthetic DFA logs along the trajectory of a proposed borehole. This integrated geological model is updated with the newly acquired data such as (but not limited to) LWD logs, wireline formation evaluation and formation testing and sampling data. The synthetic DFA logs are also updated after measuring the actual formation pressure and temperature prior to sampling in order to reflect the effects of density variation in the absorption spectrum, and other fluid properties. During sampling, the synthetic logs are contrasted with the real measurements to assist with reservoir description, e.g., by verifying accuracy and prompting update. Agreement between the integrated geological model and real measurements may be interpreted as verification of the geological model. Disagreement may be indicative of inaccuracy in the geological model, e.g., because of the existence of previously unknown hydraulically isolated regions, among other things.

When production data becomes available, the calibrated fluids model may help optimize the process of history matching and production forecast with dynamic reservoir simulation.

Another advantage of at least one embodiment of the invention is improved exploration and field development. The measured fluid properties are used to create a model that captures the variations of fluid properties throughout the reservoir. Consequently, the model helps to discern whether variations observed in the fluids are due to natural segregation of certain components in the hydrocarbons or to geological features that prevent the fluids from mixing, e.g., reservoir compartment(s). The fluid model can also be used in dynamic reservoir simulation to predict the evolution of the reservoir under different production scenarios.

Further features and advantages of the invention will become more readily apparent from the following detailed description when taken in conjunction with the accompanying Drawing.

### BRIEF DESCRIPTION OF THE DRAWINGS

FIG. 1 illustrates a borehole logging tool performing downhole fluid analysis.

FIG. 2 is a workflow diagram of a technique for facilitating oilfield development with downhole fluid analysis.

FIG. 3 illustrates results generated by the technique of FIG. 2.

### DETAILED DESCRIPTION

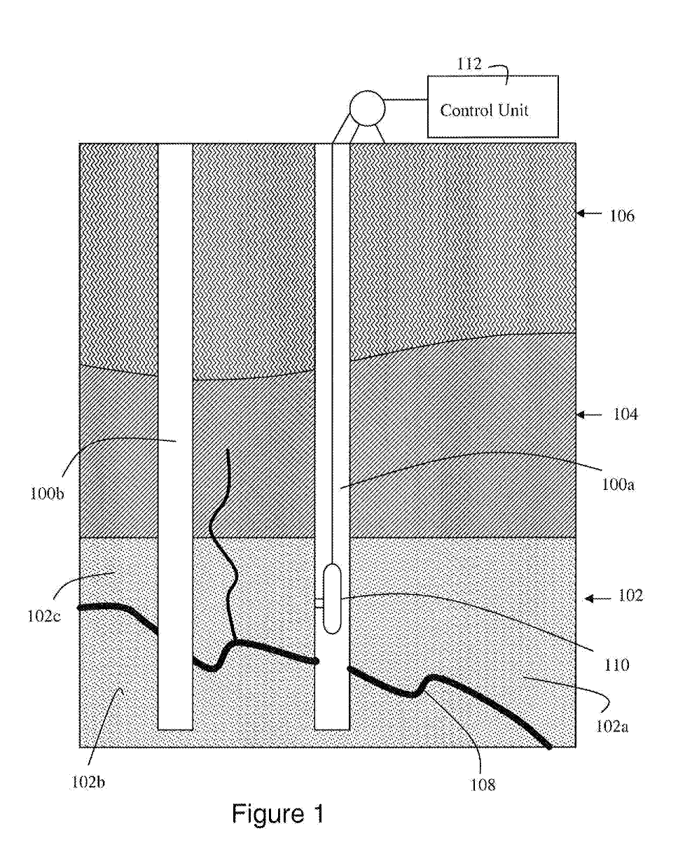

FIG. 1 illustrates boreholes (100a, 100b) drilled in a hydrocarbon field. The formation surrounding the borehole includes a hydraulically permeable layer (102) below an impermeable layer (104), and various other layers which make up the overburden (106) (not shown to scale in FIG. 1). Natural features such as a relatively thin impermeable layer (108) hydraulically isolates regions (102a, 102b, 102c) of the permeable layer, e.g., vertically, horizontally or both, such that the field is actually an aggregation of relatively small reservoirs. It will be appreciated that a well configured for recovery from only one of the hydraulically isolated reservoir will not recover fluid from another isolated reservoir.

A fluid analysis tool (110) is utilized to test fluid from the formation adjacent to the borehole (100a) in order to help identify locations of hydraulically isolated regions and other features. Differences in pressure and fluid properties generally indicate lack of hydraulic communication. However, reservoir regions that are in hydraulic communication are not always homogeneous, and more likely present smooth pressure and composition gradients. It is also possible for different regions in hydraulic communication to exist at similar pressures, but with different fluid properties. Downhole fluid analysis (DFA) provides fast and reliable information about fluid properties such as gas-oil-ratio (GOR), composition, density, viscosity, saturation pressure, and fluorescence which can be used to differentiate fluid samples. Fluid analysis can even be done in real time. It is also possible to compare acquired data with measurements from different depths in the same borehole (100a), with other samples in other boreholes, e.g., borehole (100b), in the same field, or with samples from other relevant nearby fields (See System and Methods of Deriving Fluid Properties of Downhole Fluids and Uncertainty Thereof, L. Venkataramanan, G. Fujisawa, B. Raghuraman, O. Mullins, A. Carnegie, R. Vasques, C. Dong, K. Hsu, M. O'Keefe and H-P Valero, US 2006/0155474).

One key metric used for DFA is the visible near-infrared (VIS-NIR) absorption spectrum of a fluid sample extracted from a geological formation with the fluid analysis tool (110). The absorption spectrum of a sample is related to its composition, and thus can be used to identify features such as concentration of chromophores (color), and the concentration of hydrocarbon and other molecular groups (H₂O, CO₂). The VIS-NIR absorption spectrum measurement is done in situ, at downhole conditions soon after drilling through the formation, and thus provides an early analysis of the fluids. In particular, the tool (110) is equipped with a probe that withdraws fluid from the formation and almost immediately tests the fluid, i.e., before pressure, temperature and other conditions change the fluid properties. Other measurements such as the fluorescence spectrum, closely related to optical absorption, density and viscosity made at the same time can be used to assist with the differentiation of the fluids.

In operation, the fluid analysis tool (110) is secured to a spool of cable located at the surface. The cable is spooled out in order to lower the tool into the borehole to a desired depth, e.g., adjacent to permeable layer (102). The fluid analysis tool is in communication with a control unit (112) located at the surface via electrical, optical, wireless, or other suitable communications links, through which data and instructions may be transmitted and received. In the illustrated embodiment, the fluid analysis tool is responsive to instructions transmitted from the control unit (112) to take a measurement, and transmit raw measurement data to the control unit in real time. The control unit can perform further calculations to refine the raw data and generate refined data in desired units of measure, with particular accuracy and resolution. Alternatively, the tool might operate autonomously, and might accumulate data in memory for subsequent retrieval, e.g., when brought to the surface. In order to obtain measurements in a timely manner, the measurements are made at discreet intervals in the borehole.

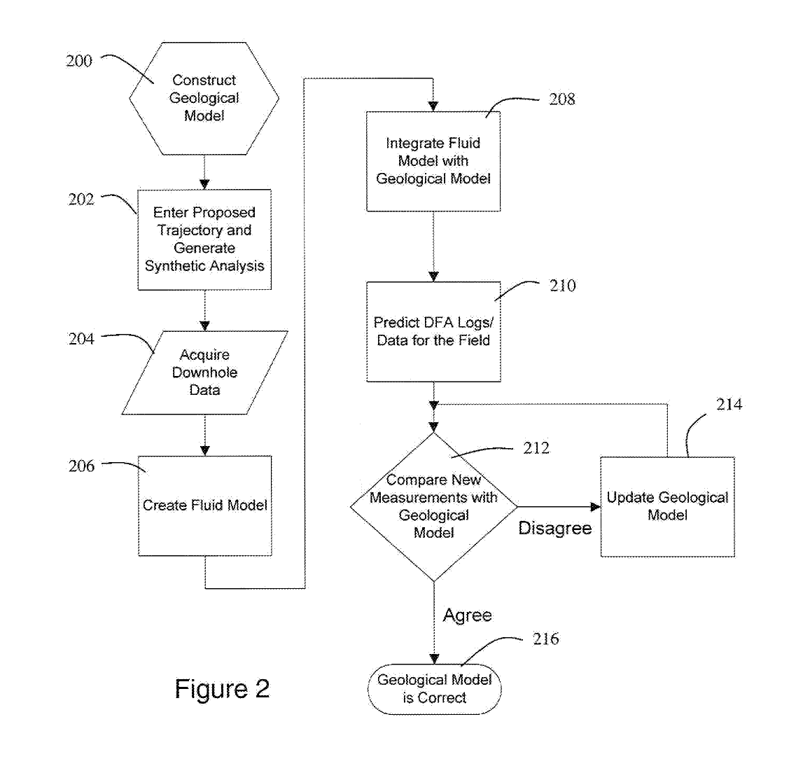

Referring now to FIGS. 1 and 2, the refined data is utilized to generate a fluid model which is integrated with a geological model in order to iteratively generate a more accurate geological model. The geological model is a mathematical representation of reservoir features pertaining to formation properties at different locations. The fluid model is a mathematical representation of fluid properties, at least one of which can be used to assess the probability of hydraulic communication between different locations. The illustrated technique utilizes DFA data to facilitate identification of fluid differences which, if contradictory to the geological model, suggest the existence of reservoir features such as isolated regions that should be analyzed and understood for a more accurate geological model, and more efficient reservoir development.

In preparation for operation, an initial geological model is constructed in step (200). In order to do this the control unit (112, FIG. 1 ) imports the trajectories of existing boreholes and available formation evaluation logs into Reservoir Characterization, 3D Modeling and Visualization software. Formation evaluation logs may include any combination of lithology, saturation, porosity, formation pressure, mobility, downhole fluid analysis, including the optical spectrum of the fluids at downhole conditions, gas-oil ratio, composition, density, viscosity, saturation pressure, water pH, and fluorescence. Seismic data could also be imported. The geological (earth) model is then generated with imported data. Alternatively, a pre-existing geological model may be imported. The geological model may include porosity, permeability, and water saturation and geological features like faults. It is also possible to work with a reservoir simulation grid. Several realizations of the model could also be loaded or created, as desired. Pressure and temperature gradients are calculated for the field using the available pressure and temperature measurements, and the results used to populate the geological model. Similarly, fluid composition, density and viscosity, and gas-oil contact, if applicable, are predicted with an equation of state or fluid property correlation tuned to measured fluid composition and PVT data from laboratory or downhole analysis of actual samples. The initial geological model is populated with fluid data using the pressure and temperature model of the field generated from lab analysis, if available.

In a subsequent step (202), at least one proposed trajectory of a new borehole is entered. Corresponding synthetic geological, petrophysical and downhole fluid analysis logs are then generated along the proposed borehole trajectory using the initial geological and fluid models. The borehole, e.g., borehole (100a, FIG. 1) is then drilled along the proposed trajectory. During drilling the borehole trajectory is updated with actual measurements and any available formation evaluation logs are acquired as they become available, as indicated in step (204). Typically, measurements will be taken at discreet intervals and the model predicts conditions between measurements. Formation evaluation logs include lithology, saturation, porosity, formation pressure, mobility, downhole fluid analyses, and geological logs. Among the measured fluid properties are GOR, composition, density, viscosity, saturation pressure, fluorescence and water pH measured in situ, i.e., either in the formation or soon after extraction from the formation and before pressure and temperature variations cause irreversible changes in fluid properties.

The acquired fluid properties are utilized to generate a more accurate fluid model as indicated in step (206). The generated fluid model is then integrated with the geological model as indicated in step (208). The integrated model is utilized to predict DFA logs and other data for the field as indicated in step (210). New measurements are then compared with the updated geological model as shown in step (212) to identify areas of agreement and disagreement, i.e., between the predicted and actual DFA logs. In the case of disagreement, the geological model is updated as shown in step (214), which may require additional logging operations. For example, if predicted conditions differ at a given location, measurements may be taken both directly at, and adjacent to, that location. This process is iterated until agreement between the predicted DFA logs of the geological model and actual DFA logs is obtained, at which point the geological model is determined to be correct, as indicated in step (216).

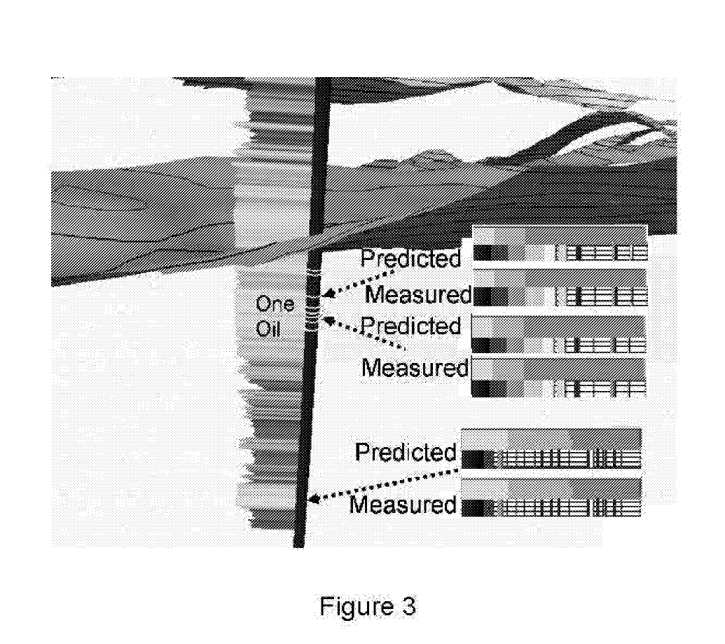

Referring now to FIGS. 2 and 3, the synthetic downhole fluid analysis logs generated along the new borehole trajectory prior to the actual measurements may be displayed by reservoir characterization software executed by the control unit. The display may represent user selected depths or intervals along the borehole path with other formation evaluation logs measured in this borehole. This includes calculating the VI-NIR absorption spectrum of the formation fluid as it is measured with a downhole fluid analyzer using, as an input, the predicted fluid composition and density from measurements done at other locations in the reservoir which are presumed to be in hydraulic communication with the present location. The control unit may also establish a plan for downhole fluid analysis and acquisition of fluid samples which contemplates, at a minimum, analyses of fluids at two points, i.e., top and base of each reservoir unit of interest identified from geological and petrophysical logs. Downhole fluid analysis may then be performed at selected depths according to the plan. Both the predicted and the actual analyses results may be displayed to aid the operator. As discussed above, if the samples are similar then the new information supports the existing reservoir model. However, if the fluid properties differ, the software prompts acquisition of additional information to gain a better understanding of the formation, e.g., performing DFA at other depths in the borehole to determine if the region of disagreement is a reservoir compartment with different fluid properties. If two different fluid samples in what was perceived as a single compartment indicate different compartments in the reservoir, the model and display are updated to reflect this condition.

An additional feature of the reservoir characterization software is the implementation of an expert system following the recommended practices presented in System and Methods of Deriving Differential Fluid Properties of Downhole Fluids, L. Venkataramanan, O. C. Mullins and R. R. Vasques, US 2006/0155472, which suggests new fluid analysis point or points in the borehole. For instance, if two downhole fluid analyses performed at the top and at the bottom of what is believed to be a single reservoir compartment are found to be different, then there is a visual display in the software marking a point in the borehole image between the two previous analyses points in order to prompt the operator to extract fluid and perform a DFA at that location. The software may also suggest under which circumstances it is advisable to capture a fluid sample.

The reservoir characterization software may also perform statistical analysis. For example, the downhole fluid analysis data of the new sample may be compared on a statistical basis to all, or a selected subset of, fluid samples in the same and other boreholes in the field to calculate their statistical similarity. Further, the volume of reserves may be automatically recalculated in response to updating of the geological model.

In order to facilitate operator understanding of field structure, the reservoir characterization software may display key elements of the geological and fluid property model in three dimensions, along with data representing fluid samples collected from the field. In the illustrated example sample similarity is distinguished by different color codes or symbols. The statistical similarity may also be represented by probability maps and these could be regenerated every time a new data point is acquired.

Calculating the predicted VIS-NIR spectrum of the fluid at a new location is done using the fluid density and composition at the new location, and the measured spectrum or spectra at a different location in the same reservoir compartment or expected trend from neighboring compartments, in any of various ways. A fluid spectrum measured at a different location in the same reservoir compartment is corrected to the expected fluid density (p) at the new location multiplying by the density ratio:

$${OD}_{2} = {OD}_{1} \frac{{ρ}_{2}}{{ρ}_{1}} ,$$

where OD is the optical density of the fluid at a given wavelength. If the composition is expected to be different at the new location, as predicted for instance from an EoS, the new composition is used to calculate the optical absorptions in the near-infrared range. A fluid color trend may be calculated with respect to a hydrocarbon component, such as C20+. The color at a different location may then be calculated knowing the composition gradient for that reservoir and the absorption decay width in the near-infrared region for hydrocarbons. If not enough information is available to calculate a composition gradient or a color gradient, the hypothesis is that the same measured fluid spectrum is expected to be encountered throughout the reservoir. Then the whole geological model is populated with a homogeneous DFA spectrum.

In some cases the fluid parameters that are typically used for discriminating samples, such as composition and gas-oil ratio (GOR), have minimal variation. However, sample differentiation may still be possible using fluid color, i.e., the optical density of the fluid at a given wavelength. In any case, naturally occurring fluid variations within a reservoir should be taken into account. In contrast to lighter crude oils that are more likely to exhibit light end variations due to gravity (variations in GOR), there is a class of moderate weight crude oils which are more likely to exhibit gravitationally induced asphaltene grading with minimum or negligible light end grading. Finally, very heavy oils often exhibit heavy end grading; biodegradation is thought to be a prime contributor here. For a given hydrocarbon accumulation there will be a linear relationship between asphaltene content and optical density (OD) of the fluid at a cut-off wavelength.

When a gravitational segregation of the heaviest fraction, i.e., asphaltenes, with depth exists in a field, it will be reflected by a variation in the NIR absorption spectra of the fluids. Fluids having a higher optical density or more asphaltene content are to be found deeper in the reservoir. Asphaltene segregation may be reproduced by physical models such as Boltzmann's law for component distribution in a gravitational field. The fluid model will enable calculations of the asphaltene content at any depth in the reservoir and hence the optical density of the fluid at the cut-off wavelength.

Crude oils and asphaltenes exhibit an exponential decay in the color dominated region of the VI-NIR spectrum with a constant decay width (See O. C. Mullins, “Optical Interrogation of Aromatic Moieties in Crude Oils and Asphaltenes”, in Structures and Dynamics of Asphaltenes, O. C. Mullins and E. Y. Sheu, editors, Plenum Press, New York, 1998). This is the base of the de-coloration algorithm for GOR correction. The fact that in a semilog plot of wavenumber vs. OD the absorption edge of crude oils displays as straight lines with constant slope is used to calculate the OD's at other wavelengths in the color dominated region (up to 1600 nm) knowing the OD at the cutoff wavelength and the slope.

Other models exist to reproduce gravitational segregation of lighter components. The fluid composition may then be calculated at any point in the field and thus the GOR. Any natural composition gradient in the fluid should be taken into account in order to calculate the synthetic optical spectrum of the fluid in the reservoir. The synthetic spectrum is then compared to the measured spectrum and their similarity is quantified.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative structures, one skilled in the art will recognize that the system may be embodied using a variety of specific structures. Accordingly, the invention should not be viewed as limited except by the scope and spirit of the appended claims.

What is claimed is:

1. A method for identifying hydraulically isolated units in a geological formation comprising the steps of:
obtaining a sample of formation fluid at a selected location;
measuring at least one property of the formation fluid within the borehole; and
utilizing the measured property to identify a hydraulically isolated geological unit.

2. The method of claim 1 wherein the at least one property includes one or more of visible near-infrared absorption spectrum, gas-oil-ratio, composition, density, viscosity, saturation pressure, and fluorescence.

3. The method of claim 1 wherein the at least one property is measured at substantially the same pressure and temperature as the formation at the selected location.

4. The method of claim 1 including the further step of utilizing measurements of the same property obtained at a plurality of selected locations to generate a fluid model.

5. The method of claim 4 including the further step of integrating the fluid model with a geological model.

6. The method of claim 5 including the further step of comparing a subsequently obtained measurement of the fluid property with the geological model.

7. The method of claim 6 including the further step of updating the geological model if the subsequently obtained measurement disagrees with the geological model.

8. The method of claim 6 including the further step of comparing measurements of the fluid property obtained at different locations within the borehole.

9. The method of claim 6 including the further step of comparing measurements of the fluid property obtained from different boreholes.

10. A computer readable medium encoded with program code for identifying hydraulically isolated geological units in a formations comprising:
logic for generating a measurement of at least one property of the formation fluid within the borehole from a sample of formation fluid obtained at a selected location; and
logic for utilizing the measured property to identify a hydraulically isolated geological unit.

11. The computer readable medium of claim 10 wherein at least one property includes one or more of visible near-infrared absorption spectrum, gas-oil-ratio, composition, density, viscosity, saturation pressure, fluorescence, and water pH.

12. The computer readable medium of claim 10 wherein the at least one property is measured at substantially the same pressure and temperature as the formation at the selected location.

13. The computer readable medium of claim 10 further including logic for utilizing measurements of the same fluid property obtained from a plurality of selected locations to generate a fluid model.

14. The computer readable medium of claim 13 further including logic for integrating the fluid model with a geological model.

15. The computer readable medium of claim 14 further including logic for comparing a subsequently obtained measurement of the fluid property with the geological model.

16. The computer readable medium of claim 15 further including logic for updating the geological model if the subsequently obtained measurement disagrees with the geological model.

17. The computer readable medium of claim 15 further including logic for comparing measurements of the fluid property obtained at different locations within the borehole.

18. The computer readable medium of claim 15 further including logic for comparing measurements of the fluid property obtained from different boreholes.

19. Apparatus for identifying hydraulically isolated geological units in a formations comprising:
a formation analysis tool operable to obtain a sample of formation fluid at a selected location, and to measure at least one property of the formation fluid within the borehole; and
a control unit operable to utilize the measured property to identify a hydraulically isolated geological unit.

20. The apparatus of claim 19 wherein the at least one property includes one or more of visible near-infrared absorption spectrum, gas-oil-ratio, composition, density, viscosity, saturation pressure, fluorescence, and water pH.

21. The apparatus of claim 19 wherein the at least one property is measured at substantially the same pressure and temperature as the formation at the selected location.

22. The apparatus of claim 19 wherein the control unit is further operable to utilize measurements of the same property obtained at a plurality of selected locations to generate a fluid model.

23. The apparatus of claim 22 wherein the control unit is further operable to integrate the fluid model with a geological model.

24. The apparatus of claim 23 wherein the control unit is further operable to compare a subsequently obtained measurement of the fluid property with the geological model.

25. The apparatus of claim 24 wherein the control unit is further operable to update the geological model if the subsequently obtained measurement disagrees with the geological model.

26. The apparatus of claim 24 wherein the control unit is further operable to compare measurements of the fluid property obtained at different locations within the borehole.

27. The apparatus of claim 24 wherein the control unit is further operable to compare measurements of the fluid property obtained from different boreholes.
